(19) United States
(12) Patent Application Publication
(10) Pub. No.: US 2026/0120094 A1
(43) Pub. Date: Apr. 30, 2026

(54) SYSTEMS AND METHODS FOR BLOCKCHAIN-BASED FINANCIAL TRANSACTIONS AND TRADE MANAGEMENT

(71) Applicant: TradeNetrix, Inc., Lanham, MD (US)

(72) Inventor: Hatib Prom, Lanham, MD (US)

(21) Appl. No.: 19/368,838

(22) Filed: Oct. 24, 2025

Related U.S. Application Data
(60) Provisional application No. 63/711,304, filed on Oct. 24, 2024.

(51) Int. Cl. G06Q 20/38; G06Q 20/40

(52) U.S. Cl. CPC G06Q 20/389; G06Q 20/4016

(57) ABSTRACT

Systems and methods for computer-implemented commodity transactions using blockchain-based smart contracts. A server with memory executes application to authenticate buyer and seller, receive listing with commodity identifier, quantity, quality, delivery terms, price; generate smart contract specifying participant identifiers, wallet or banking info, order and contract IDs, milestone events, settlement terms; commit contract to blockchain; escrow funds associated with contract; obtain shipment, inspection, and delivery status via oracle; verify milestone satisfaction; release escrowed funds accordingly; record settlement on chain; and update database. Modules may include compliance to compute taxes and fees, identity to perform KYC/AML, and dispute resolver to execute predefined remedies. Optional multisignature escrow and fiat or crypto settlement are supported. Executions store hashes and ledger indices to provide tamper evident audit trails.

### CROSS-REFERENCE TO RELATED APPLICATIONS

The present application claims priority to U.S. Provisional Application No. 63/711,304 filed Oct. 24, 2025, titled “SYSTEMS AND METHODS FOR BLOCKCHAIN-BASED FINANCIAL TRANSACTIONS AND TRADE MANAGEMENT,” which is hereby incorporated by reference in its entirety.

### TECHNICAL FIELD

The embodiments generally relate to the technical field of systems and methods for blockchain-enabled commodity trading and settlement.

### BACKGROUND

Conventional electronic commodity trading platforms connect buyers and sellers through centralized web applications that maintain account records, product catalogs, bids and offers, and trade confirmations in hosted databases. Users authenticate through credential checks, submit listings that specify product attributes and delivery terms, and engage through matching engines that pair orders according to price and quantity. After execution, the platform issues confirmations and generates trade tickets that downstream systems use for invoicing, shipping coordination, and payment initiation.

Payment and settlement in conventional systems typically rely on banking networks and third-party payment processors. Platforms route funds through wire transfers, automated clearing house rails, or card networks, and many employ custodial or trust-style escrows administered by financial intermediaries. These arrangements provide structured controls but introduce sequential steps for funding, hold release, and reconciliation, each of which depends on confirmations from parties that operate outside the trading platform's core datastore.

Shipping status and delivery verification frequently draw on integrations with carriers and logistics providers. Platforms consume tracking feeds, electronic data interchange messages, or application programming interfaces to map events such as pickup, in transit, customs clearance, and delivery. Inspection outcomes, weight tickets, and quality certificates often arrive as documents or structured messages that the platform associates with a trade record. Dispute handling and exceptions management commonly involve workflows that direct human reviewers to check documents, confirm milestones, and approve adjustments.

Compliance and reporting functions in conventional systems aggregate transaction data to calculate taxes, tariffs, and fees based on jurisdictional rules. Audit logs, access controls, and versioned records support oversight while batch exports feed enterprise resource planning systems and external auditors. These approaches operate effectively at scale, yet they tend to require multiple integrations, periodic reconciliations across systems of record, and coordination among participants for release conditions, cross border payments, and final settlement timing.

Enablement of governments and trade authorities to autonomously enforce trade policy (trade governance) through a modular, blockchain-enabled infrastructure. The system integrates preferential trade agreement (PTA) onboarding, tariff and quota management, compliance verification, and Environmental, Social, and Governance (ESG)-linked enforcement into a unified architecture. Smart contract features engine that codifies Rule of Origin criteria, quota thresholds, and ESG triggers, enabling real-time tariff adjustments and credential validation. Supports API-based interoperability with customs, logistics, and payment systems, and includes a dashboard layer for monitoring trade flows, utilization rates, and policy compliance. The platform's design allows for scalable deployment across bilateral, multilateral, and regional trade frameworks, with built-in audit trails and legal document repositories to support transparency and dispute resolution. This invention provides a novel mechanism for digitizing and automating trade governance, reducing administrative friction, and enhancing policy accountability.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed system provides a computer implemented platform that orchestrates listing, contracting, trade governance, escrow, delivery verification, and settlement for commodity and financial transactions using a server, networked user devices, and a database coupled to a blockchain interface. Executable instructions on the server create a smart contract from seller supplied listing data that includes participant identifiers, account or wallet information, order and contract identifiers, milestone events, and settlement terms. The platform commits the smart contract to a blockchain ledger and associates an escrow with that contract so that funding, release conditions, and settlement are governed programmatically and recorded immutably.

The disclosed system receives shipment and inspection information from external logistics sources through an interface and maps carrier events and inspection outcomes to predefined milestone events. The platform verifies delivery by comparing received status signals to the milestone definitions and then releases funds in whole or in programmable parts based on those verifications. By binding delivery evidence directly to release conditions within the smart contract, the platform reduces sequential reconciliations and manual approvals that conventional systems conduct across separate payment and tracking tools.

The disclosed system integrates compliance and identity controls into the same transaction flow. A compliance engine computes jurisdiction specific taxes, tariffs, and fees and injects those values into contract parameters prior to on chain commitment, while an identity module performs credential checks, decentralized identifier validation, and know your customer and anti money laundering screening before enabling payment. These modules generate audit ready records that the database stores alongside chain identifiers and block hashes so that off chain and on chain views remain consistent without periodic batch reconciliation.

The disclosed system further provides optional multisignature escrow management, fiat to crypto conversion at funding and vice versa, and programmatic dispute resolution that executes predefined remedies when inspection data indicates a variance from delivery terms. Post settlement reputation updates and inventory adjustments can be anchored to the ledger for tamper evident traceability. Collectively, these mechanisms address functional limitations of conventional platforms by coupling execution, evidence, and settlement within a unified, verifiable workflow that operates across trading, logistics, compliance, and payments in real time.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates an exemplary class and interaction diagram for a system that orchestrates listing, contracting, trade governance, delivery verification, and settlement, according to some embodiments; and

FIG. 4 illustrates an example method executed by a computing system to coordinate contracting, delivery verification, and settlement, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A networked computing environment may host server/cloud based side components that coordinate listing, contracting, escrow, tariffs (trade governance), delivery verification, and settlement. One or more servers/cloud based server may include processors, memory, nonvolatile storage, and network interfaces that expose application programming interfaces over a network to authenticated client devices. A load balancer may distribute incoming requests to stateless application instances while a persistent database cluster maintains transactional state. Client devices may include mobile phones, tablets, and desktop systems that render web or native interfaces and communicate with the servers using encrypted channels.

An application layer on the servers may include a smart contract generator that transforms seller supplied listing data into a machine readable contract artifact. The generator may accept a payload that specifies a seller identifier, a buyer identifier, local government fee identifier, a commodity identifier, quantity, quality attributes, delivery terms, settlement terms, and payment instrument information. The generator may normalize field formats, validate ranges, and derive secondary fields such as calculated taxes, tariffs, and milestone identifiers. The module may serialize the resulting contract into a canonical structure that can be signed, versioned, and committed to a ledger.

A blockchain interface may connect the application layer to a blockchain network using a node gateway or a hosted provider. The interface may expose operations to create addresses, fund addresses, construct transactions, sign payloads, broadcast transactions, and query chain state. In one example the interface may target an XRPL network, and the module may map contract fields to XRPL transaction types, including escrow creation, escrow finish, and on ledger memos for human readable annotations. The interface may maintain a retry queue and confirmation watcher that correlates submitted transaction hashes with observed ledger validations and records block or ledger indices for auditability.

An escrow manager may coordinate funding and conditional release of value associated with a contract. The escrow manager may support single signature escrows, multisignature escrows, and time bound or event bound release conditions. For multisignature operation the module may register participant public keys and required signature thresholds and may present signing requests to designated parties through the client applications or secure message channels. The manager may hold on chain the funded amount as a locked balance and may monitor triggers referenced by the contract's milestone definitions to determine when to request signatures or to automatically complete an escrow finish transaction.

An oracle adapter may consume shipment, inspection, and delivery data from logistics systems. The adapter may poll or receive webhook notifications from carriers, freight forwarders, warehouse management systems, and inspection services. The adapter may normalize external events such as pickup, in transit, customs clearance, out for delivery, delivered, and inspection pass or fail into a common event model. The module may map each normalized event to a contract milestone using a rule set stored in the database and may emit state transitions that other modules consume.

A delivery verifier may evaluate whether a milestone has been satisfied by comparing the contract's conditions with the oracle adapter's event stream. The verifier may implement deterministic rules, for example requiring an event of type delivered with a carrier confirmation code and a geofence match to a specified destination coordinate. For inspections the verifier may accept structured reports or signed attestations from approved inspectors and may compute a pass or fail outcome relative to tolerance thresholds defined in the contract's quality attributes. The verifier may write a milestone satisfaction record that includes the time, the data used for evaluation, and a hash of the evidence payload stored in object storage.

A settlement controller may apply milestone outcomes to payment release logic. The controller may read the contract's schedule, for example an initial deposit at contract commitment, a second release upon pickup, and a final release upon delivery verification. The controller may request escrow completion when a milestone is satisfied, and may split a payment into multiple recipients if the contract specifies fees, commissions, tariffs or taxes. When operating with cryptocurrency the controller may sign and submit ledger transactions through the blockchain interface. When operating with fiat rails the controller may call a payment processor and record external settlement identifiers while still anchoring a proof of settlement on chain through a memo or reference transaction.

A dispute resolver may execute when the delivery verifier indicates a discrepancy relative to the contract's delivery terms or quality thresholds. The dispute resolver may read a set of programmatic remedies defined in the contract, including options to release a partial amount to the seller, return funds to the buyer, or hold funds pending additional inspection. The module may compute the applicable remedy and may either perform the remedy automatically or submit a decision package to designated approvers when a multisignature escrow requires additional authorizations. The resolver may record each decision step and may include hashes of evidence to preserve a tamper evident trail.

An identity service may authenticate participants and enforce compliance checks before allowing contract creation or payment operations. The service may support user credentials, multifactor authentication, and decentralized identifiers. The service may ingest know your customer and anti money laundering data, validate government issued documents through third party providers, and assign verification statuses to accounts. The identity service may sign a verification assertion that the smart contract generator can reference as a prerequisite, and the system may prevent funding of an escrow until the identity checks return a passing state.

A compliance engine may compute taxes, tariffs, and regulatory fees based on shipment attributes, product categories, and jurisdictions. The engine may maintain rulesets that define rates and exemptions and may request country specific codes such as HS codes from a classification service. The engine may insert computed amounts into the contract's parameter set and may publish a breakdown used by the settlement controller to route allocations to appropriate recipients. The engine may also generate reports required by customs or financial regulators and may store the reports for retrieval by authorized parties.

A database layer may persist structured state across the platform. The schema may include a user table with fields for user identifiers, role assignments, wallet addresses, verification status, and public keys. An order table may store order identifiers, buyer and seller references, commodity identifiers, quantities, and status flags that track lifecycle progression. A contract table may store contract identifiers, serialized contract documents, signature references, milestone schedules, and computed financial terms. A blockchain table may store chain identifiers, transaction hashes, ledger indices, and timestamps. A delivery verification table may store verification identifiers, associated order identifiers, evidence hashes, and outcome codes. A transaction table may store transactions with direction, amount, currency, settlement channel, and a pointer to either an on chain transaction hash or an off chain processor reference. The database may enforce foreign key constraints and may expose views that join records for audit and analytics.

A file or object storage service may hold large artifacts such as inspection photos, bills of lading, and signed attestations. The system may compute a cryptographic hash for each artifact and may store the hash in the database and optionally in the memo field of a blockchain transaction. The platform may serve artifacts to authorized users through time limited URLs and may log each access event for compliance review.

A user interface layer may present role specific workflows. A seller interface may allow creation of listings, selection of terms, and preview of generated contract parameters before commitment. A buyer interface may allow review of listings, initiation of purchases, funding of escrows, and monitoring of shipment status. An administrator interface may allow configuration of rules, review of disputes, and management of keys and compliance providers. The interface may subscribe to a server sent event stream or a websocket channel that emits milestone updates, ledger confirmations, and settlement receipts in near real time.

A key management component may protect signing keys used for blockchain transactions and for internal attestations. The component may integrate with hardware security modules or cloud key vaults and may enforce role based access controls and quorum policies for sensitive operations such as escrow completion. The component may rotate keys according to policy and may export only public keys to other modules.

A messaging bus may connect modules in an event driven pattern. The oracle adapter may publish events such as shipment status updates. The delivery verifier may subscribe to those events and publish milestone outcomes. The settlement controller may subscribe to milestone outcomes and publish settlement events. The escrow manager may subscribe to settlement events and submit on chain transactions. The architecture may allow horizontal scaling by increasing consumer instances and may provide at least once delivery with idempotent handlers to avoid double processing.

A monitoring and audit service may aggregate logs, metrics, and traces from all modules. The service may capture each significant state transition with the acting user or service principal, input parameters, and resulting outputs. The system may write an immutable audit record by including a hash of the log entry in an on chain memo after key lifecycle milestones, which allows an auditor to reconcile database records with ledger anchors.

An optional reputation module may compute participant scores using completed transaction outcomes and peer feedback. The module may weight on time delivery, dispute occurrences, and confirmation latencies. The module may anchor a summary reputation update on chain by writing a signed statement to the ledger and may store the detailed calculation off chain.

An inventory integration may maintain available quantities for commodities that the seller lists. The system may expose webhooks or blockchain native hooks that adjust available quantity upon contract commitment and upon settlement. When a ledger supports hooks the blockchain interface may trigger a contract specific hook that updates an inventory state associated with the seller's address.

A typical transaction flow may start when a seller authenticates, creates a listing, and submits listing data. The smart contract generator may create a contract document and present it for review. Upon approval the blockchain interface may commit a contract anchoring transaction. The buyer may fund an escrow through either a cryptocurrency payment routed to an escrow account or a fiat payment processed through a payment gateway, in which case the system may convert part of the funds into on chain value if the contract requires on chain settlement. The oracle adapter may begin monitoring logistics events and the delivery verifier may evaluate milestones as events arrive. The settlement controller may effect staged releases and record settlements. The resolver may handle discrepancies according to the contract's remedies. The database may reflect the transaction as complete and the system may emit a final settlement receipt to both parties.

The modules may be implemented as microservices that each expose a REST or gRPC interface. Each service may include its own data store for local state and a shared relational database for cross cutting records. Services may authenticate requests using signed tokens issued by the identity service and may authorize actions based on roles and ownership of specific resources. Services may be deployed in containers orchestrated by a scheduler and may use horizontal pod autoscaling based on queue depth or request latency.

The platform may include safeguards for failure modes. If the blockchain interface fails to obtain confirmation within a timeout window it may resubmit transactions with the same nonce when the target ledger supports idempotent sequencing. If the oracle adapter misses a webhook the adapter may reconcile by polling recent activity windows. If the settlement controller detects inconsistent states it may place the contract into a manual review queue without releasing funds and may notify participants.

The system may support multiple ledgers by implementing a provider abstraction in the blockchain interface. Each provider may define transaction formats and signing workflows specific to a ledger. The escrow manager and settlement controller may call provider neutral methods that the interface dispatches to the correct provider based on the contract's chain identifier. This approach allows the database to represent a chain identifier and a transaction hash independently of the underlying ledger.

The hardware environment for the servers may include multi core processors, volatile and nonvolatile memory, and network adapters. The processors may execute the application instructions that implement the described modules. The memory may store executable code, configuration, and working data structures such as contract documents, milestone definitions, and ledger transaction templates. The network adapters may support encrypted transport and mutual authentication to external services such as payment gateways and identity verification providers.

A data protection strategy may include encryption at rest for database and object storage and encryption in transit for all network communications. The key management component may rotate encryption keys and may enforce that application instances obtain decryption keys only when running in approved environments. The auditing service may record cryptographic fingerprints for sensitive data and may verify them periodically to detect tampering.

The system may expose developer facing interfaces that allow programmatic access to create listings, retrieve contract templates, push logistics updates, and request escrow releases. The interfaces may validate caller identities using OAuth tokens and may scope actions to resources owned by the caller. Rate limiting may protect the services from abuse and circuit breakers may prevent cascading failures when external providers experience outages.

A testing and simulation toolkit may allow operators to simulate logistics events, escrow releases, and dispute scenarios against sandbox ledgers. The toolkit may generate synthetic carrier updates and inspection results and may verify that milestone evaluations and settlement outcomes match expected results. Operators may use the toolkit to validate rule changes before deployment.

In one example the oracle adapter may ingest carrier tracking messages from a webhook that posts JSON objects with fields for tracking number, event code, timestamp, and location. The adapter may validate a signature from the carrier, translate event codes into the platform's event model, and publish an event to the bus. The delivery verifier may compare the event to a contract rule that requires a delivered code and a location within a 100 meter radius of the destination coordinate and may mark the delivery milestone as satisfied. The settlement controller may observe the milestone satisfaction, construct an escrow finish transaction that references the escrow identifier, and submit the transaction through the blockchain interface. The interface may receive a confirmation at a particular ledger index and may store that index with the settlement record.

In another example the dispute resolver may execute a remedy schedule when an inspection report indicates moisture content outside a tolerance. The resolver may compute a pro rata reduction according to a table in the contract and may release the remaining portion to the seller while returning the reduced portion to the buyer. When the escrow requires multiple signatures the resolver may issue signing requests to the parties and a neutral intermediary and may proceed after receiving the required threshold of signatures.

The platform may operate with either cryptocurrency native settlement or fiat native settlement while still providing a consistent audit trail. When using fiat native settlement the settlement controller may call a payment gateway to transfer funds between bank accounts and then submit a zero value or memo only transaction on the blockchain that references the payment processor's identifier, which creates a public anchor for the off chain event. When using cryptocurrency native settlement the controller may settle directly on chain and record the resulting transaction hash in the database.

A logging strategy may include structured logs with correlation identifiers that carry through user actions, background jobs, and blockchain confirmations. The monitoring service may index logs and expose dashboards showing counts of contracts in each lifecycle state, latency for oracle updates to milestone evaluation, and success rates of escrow finish transactions. Alerts may trigger on error rates and on unusual patterns such as repeated dispute outcomes for the same counterparty pair.

The system may support data export for enterprise integration. A reporting service may assemble contract, logistics, and settlement records into normalized exports for accounting systems. The service may support scheduled exports and on demand queries and may include cryptographic signatures so that receiving systems can verify the integrity of exported files.

Various implementations of the invention involve the technical field of blockchain-enabled commodity trading and settlement including authenticate the seller and the buyer and establish respective accounts; receive, from the seller, a listing comprising a commodity identifier, quantity, quality attributes, delivery terms, and a price; generate a smart contract for the listing that specifies at least a seller identification, a buyer identification, a wallet address or banking information, an order identification, a contract identification, milestone events comprising shipment and delivery, and settlement terms; commit the smart contract to a blockchain ledger using a blockchain interface; escrow funds for the listing in association with the smart contract; obtain shipment and delivery status from an oracle interface; verify delivery by comparing the shipment and delivery status with the milestone events; release at least a portion of the escrowed funds upon verifying the delivery; record a settlement on the blockchain ledger; and update the database to reflect completion of a transaction associated with the smart contract and are therefore necessarily rooted in computer technology. For example, the aforementioned steps are inherently computer-based and cannot be performed in the human mind. The present invention amounts to more than merely implementing the generic computer as a tool to gather, analyze, and output data because the steps of the present method, system, or product improve the blockchain-enabled commodity trading and settlement by providing a unified, computer implemented transaction flow that programmatically binds listing data, escrow funding, delivery evidence, and settlement through verifiable state transitions rather than manual reconciliations across separate tools. Server executed modules generate a smart contract, anchor it on a blockchain, ingest logistics and inspection signals through oracle adapters, evaluate milestone conditions with deterministic rules, and trigger on chain or off chain releases from escrow while recording tamper evident proofs. Identity and compliance services perform machine enforced checks before funds move, and dispute resolution executes predefined remedies using signed evidence and threshold signatures. These operations use specific computing components, cryptographic signing, ledger transaction formats, event driven state machines, and defined data structures that together transform and control payment state in response to external sensor and carrier events. The claimed processes therefore implement a technical solution to settlement timing and verification by improving how a computer system coordinates escrow, evidence ingestion, and ledger recording, rather than reciting a policy or workflow that humans could perform with generic recordkeeping. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

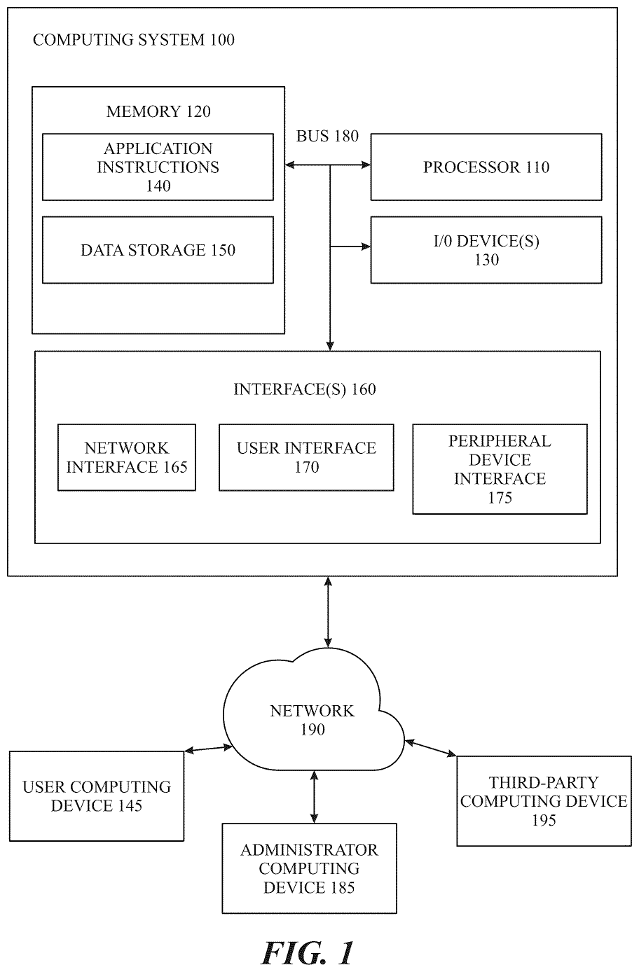

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, MongoDB, Ripple XRPL, XRPL Hooks, React.js, Node.js, AWS IoT Core, ILP, OAuth 2.0, AES-256 Encryption, Docker/Kubernetes, Docker/Kubernetes, CI/CD Pipeline as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, optical character recognition devices, sensors, biometric scanners, or environmental sensors.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart device configured to execute client-side, including government-side, applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 function within a cloud-native environment, operating as a microservice within a container orchestration platform. In edge deployments, the computing system 100 may be optimized for low-latency local processing, while synchronizing with centralized cloud infrastructure for data persistence and global coordination.

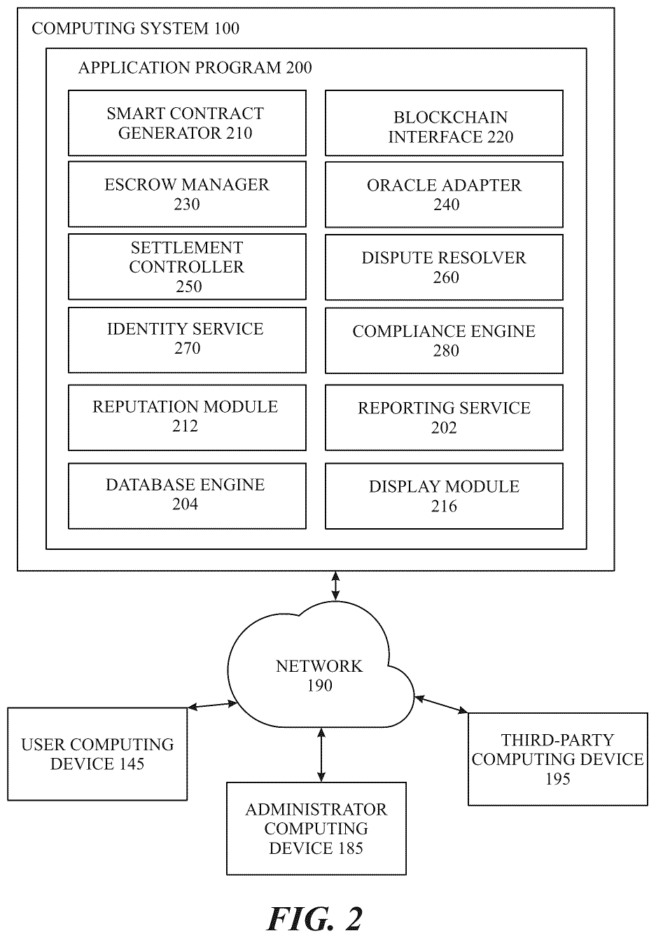

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of an avatar driver interface 210 a database engine 204, and a display module 216.

In some embodiments, the SMART CONTRACT GENERATOR 210 is configured to transform listing and participant data into a machine readable contract artifact that defines identifiers, milestone events, payment schedules, and settlement terms. The generator parses seller supplied fields, validates ranges, derives computed values such as taxes and fee allocations, and assembles a canonical document with deterministic field ordering and version tags. The module signs the artifact using keys maintained by the platform, stores a hash in the DATABASE ENGINE 204, and prepares serialized payloads that the BLOCKCHAIN INTERFACE 220 can commit on chain as one or more transactions.

In some embodiments, the BLOCKCHAIN INTERFACE 220 is configured to connect the application to a selected ledger and to submit, monitor, and confirm transactions that anchor contract state, escrows, and settlements. The interface maintains network endpoints, handles address creation and key usage through a secure signer, constructs transaction messages that map contract parameters to ledger specific fields, and watches for validations. The interface writes returned transaction hashes and ledger indices to the DATABASE ENGINE 204 and emits events when confirmations satisfy contract prerequisites.

In some embodiments, the ESCROW MANAGER 230 is configured to provision, fund, and release escrow accounts associated with an order. The manager registers participant keys, enforces signature thresholds for multisignature flows, and tracks time based or event based release conditions. The module links each escrow to the relevant contract, requests funding from a buyer wallet or payment rail, and issues completion requests through the BLOCKCHAIN INTERFACE 220 when milestone evidence indicates satisfaction, while persisting state transitions for audit.

In some embodiments, the ORACLE ADAPTER 240 is configured to ingest logistics and inspection data from external systems and to normalize those inputs into a common event model referenced by contract milestones. The adapter accepts webhook notifications or polls carrier and inspector APIs, verifies message integrity, maps provider specific codes to standardized event types such as pickup, customs cleared, delivered, or inspection passed, and forwards structured updates to downstream consumers. The adapter maintains de duplication logic and time windows to ensure idempotent processing.

In some embodiments, the SETTLEMENT CONTROLLER 250 is configured to evaluate milestone satisfaction and to direct staged releases according to the schedule embedded in the contract. The controller computes allocations for seller proceeds, fees, and taxes, determines whether settlement occurs on chain or via a fiat processor, and initiates the corresponding action. For on chain settlement the controller builds and signs completion transactions through the BLOCKCHAIN INTERFACE 220, and for fiat settlement the controller records processor references and anchors a proof to the ledger as a memo or zero value transaction.

In some embodiments, the DISPUTE RESOLVER 260 is configured to execute programmatic remedies when inspection results or delivery data deviate from contract tolerances. The resolver reads remedy rules stored with the contract, calculates adjustments such as partial refunds or holdbacks, and requests the required signatures when a multisignature policy applies. The module records evidence hashes, decision trails, and resulting transfers so that each outcome can be reconstructed from database records and on chain anchors.

In some embodiments, the IDENTITY SERVICE 270 is configured to authenticate users and to enforce verification prerequisites prior to contract creation and payment operations. The service manages credentials and multi factor challenges, validates decentralized identifiers when provided, and integrates with verification providers to perform know your customer and anti money laundering checks. The service issues signed assertions representing verification status that other modules consume before allowing escrow funding or release.

In some embodiments, the COMPLIANCE ENGINE 280 is configured to compute jurisdiction specific taxes, tariffs, and regulatory fees and to generate regulatory artifacts associated with a shipment. The engine classifies commodities, applies rule sets based on origin, destination, and product category, and writes computed values into the contract parameters so that the SETTLEMENT CONTROLLER 250 can route allocations accordingly. The engine stores report snapshots and provides query interfaces for audit and regulatory submissions.

In some embodiments, the REPUTATION MODULE 212 is configured to update participant scores based on closed transactions, dispute outcomes, on time delivery, and confirmation latency. The module aggregates metrics from the DATABASE ENGINE 204, applies a weighting model, produces an updated score, and optionally anchors a signed summary on chain for tamper evident traceability while retaining detailed calculations off chain.

In some embodiments, the REPORTING SERVICE 202 is configured to assemble operational and audit outputs from contract, logistics, and settlement records. The service exposes scheduled and on demand exports in structured formats, applies access controls, and signs exported files so receiving systems can verify integrity. The service may also generate dashboards by querying canonical views in the DATABASE ENGINE 204 that join orders, milestones, and ledger confirmations.

In some embodiments, the DATABASE ENGINE 204 is configured to persist normalized records for users, orders, contracts, escrows, deliveries, transactions, and chain metadata. The engine enforces referential integrity across tables, maintains indexes for milestone queries, and stores cryptographic hashes of artifacts and evidence. The engine supports transactional writes from the modules described above and emits change events that drive real time user interfaces and settlement logic.

In some embodiments, the DISPLAY MODULE 216 is configured to render role specific views and interactive workflows for sellers, buyers, and administrators. The module subscribes to application events to present live status of milestones, escrow funding, and ledger confirmations, and it collects structured inputs for actions such as approving a contract, authorizing a release, or acknowledging delivery. The module implements accessibility features and internationalization and adapts presentation to device capabilities while preserving the data bindings required for auditable user actions.

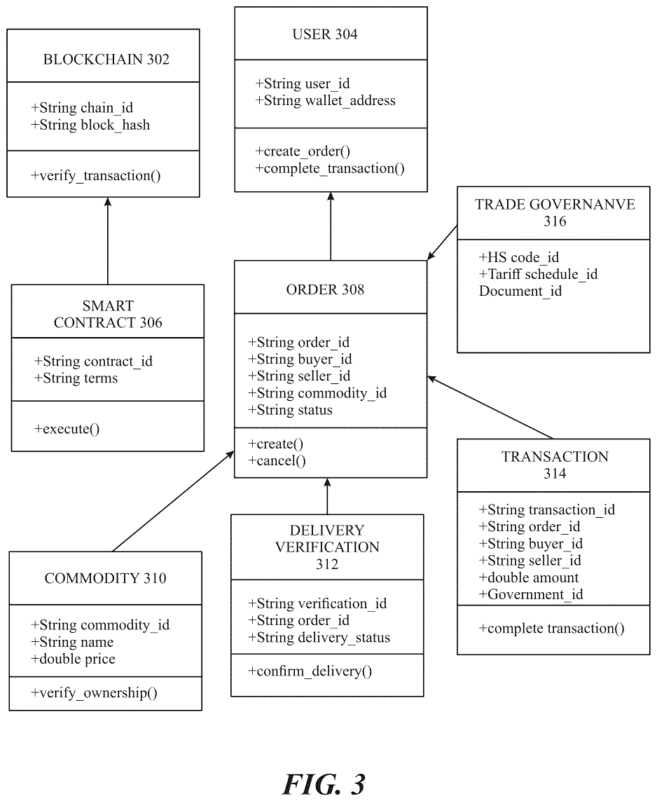

FIG. 3 illustrates an exemplary class and interaction diagram for a system that orchestrates listing, contracting, delivery verification, and settlement. A BLOCKCHAIN 302 class maintains immutable ledger metadata using attributes chain_id and block_hash and exposes a verify_transaction function that may confirm on chain events associated with a transaction or escrow. A SMART CONTRACT 306 class represents a machine readable agreement generated from listing and participant data. The class includes a contract_id and terms and provides an execute function that may submit, modify, or complete on chain instructions by invoking operations that resolve through BLOCKCHAIN 302. A COMMODITY 310 class models tradeable items and stores a commodity_id, a name, and a price, and may include a verify_ownership function that checks provenance or inventory state for a listing referenced by a contract.

TRADE GOVERNANCE 315 represent HS Code IDs, jurisdiction government tariff schedules, fees, taxes, required compliance and sustainability goals.

A USER 304 class represents authenticated participants in the system with attributes user_id and wallet_address. The class exposes create_order and complete_transaction functions that may initiate purchase flows, fund escrows, and acknowledge settlement. An ORDER 308 class captures a pending or active trade with attributes order_id, buyer_id, seller_id, commodity_id, and status. The ORDER 308 class may call create to instantiate a new order from a listing and cancel to terminate an order before fulfillment. The diagram indicates associations between ORDER 308 and USER 304 showing that a user may create an order and later complete a transaction. The ORDER 308 class also associates with SMART CONTRACT 306 and COMMODITY 310 to bind a specific contract and item to the order record.

A DELIVERY VERIFICATION 312 class records shipment outcomes and includes verification_id, order_id, and delivery_status. The class exposes confirm_delivery to register evidence from carriers or inspectors and to update milestone satisfaction for the associated order. A TRANSACTION 314 class records settlement events with attributes transaction_id, order_id, buyer_id, seller_id, government_id, and amount, and provides a complete_transaction function that finalizes payment and posts a settlement record. Associations from ORDER 308 to DELIVERY VERIFICATION 312 and to TRANSACTION 314 indicate that verified delivery may trigger completion logic and subsequent recording of a settlement event. The depicted relationships model how the disclosed system correlates users, orders, commodities, smart contracts, delivery confirmations, and on chain verification to control escrow release and record a tamper evident audit trail.

In some embodiments, the TRADE GOVERNANCE 316 component is configured to maintain and apply jurisdictional trade rules that affect an order's pricing and settlement. The component stores references to classification and regulatory artifacts using fields HS_code_id, Tariff_schedule_id, and Document_id, and associates those references with ORDER 308 during order creation and update events. The component retrieves commodity attributes from COMMODITY 310 and shipment attributes from ORDER 308, resolves the correct HS code, selects a tariff schedule version for the origin and destination pair, and links required regulatory documents such as certificates or licenses. It then computes duties, tariffs, and government fees as structured line items and emits normalized parameters that the SMART CONTRACT 306 and TRANSACTION 314 consume.

In some embodiments, the TRADE GOVERNANCE 316 component performs rule evaluation by loading machine readable schedules and thresholds into an execution engine that supports date effective versions and country specific exceptions. The component validates code selections against a catalog, records the chosen HS_code_id and Tariff_schedule_id with the order, and binds each computed assessment to a persistent Document_id that points to a stored calculation snapshot. The component exposes an interface that allows the SETTLEMENT CONTROLLER 250 to retrieve finalized amounts for allocation and allows the REPORTING SERVICE 202 to produce audit outputs. When regulations change, the component preserves prior versions and re-evaluates only orders that have not yet reached settlement, ensuring that the transaction record written by TRANSACTION 314 contains the correct assessments for the applicable period.

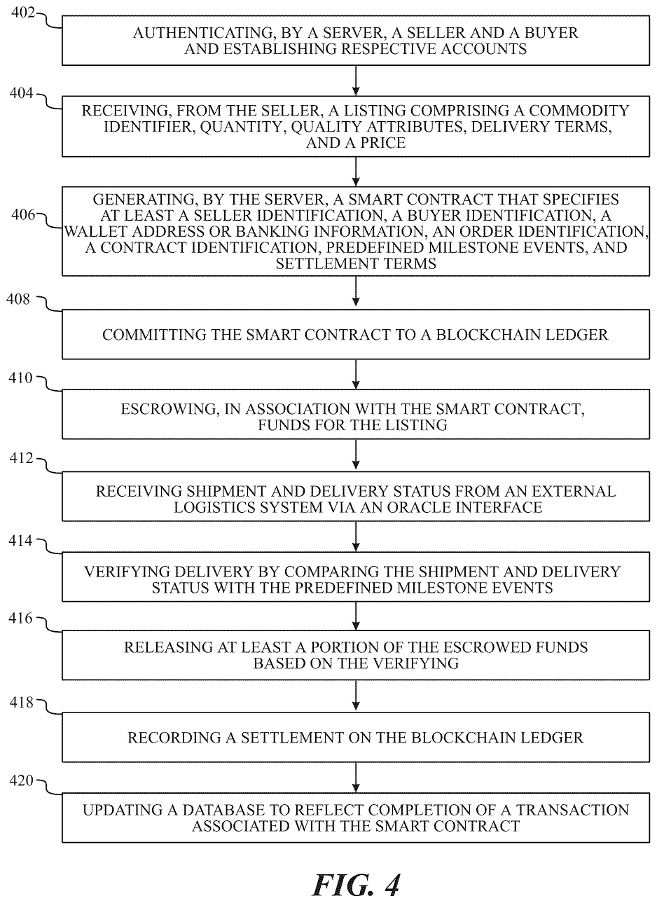

FIG. 4 depicts an example method executed by a computing system to coordinate contracting, delivery verification, and settlement. At 402, a server authenticates a seller and a buyer and establishes respective accounts, which may include credential verification and assignment of identifiers and wallet or banking references. At 404, the server receives, from the seller, a listing that includes a commodity identifier, quantity, quality attributes, delivery terms, and a price. At 406, the server generates a smart contract that specifies at least a seller identification, a buyer identification, a wallet address or banking information, an order identification, a contract identification, predefined milestone events, and settlement terms.

At 408, the system commits the smart contract to a blockchain ledger through a blockchain interface so that the contract parameters and references are immutably anchored. At 410, the system escrows funds for the listing in association with the smart contract, which may include provisioning a single signature or multisignature escrow and storing an escrow identifier. At 412, the system receives shipment and delivery status from an external logistics system via an oracle interface that normalizes provider specific messages into standardized event types.

At 414, the system verifies delivery by comparing the shipment and delivery status with the predefined milestone events specified in the smart contract and writes a milestone satisfaction record. At 416, the system releases at least a portion of the escrowed funds based on the verifying, including staged payments that correspond to the milestone schedule. At 418, the system records a settlement on the blockchain ledger and captures the resulting transaction hash and ledger index. At 420, the system updates a database to reflect completion of a transaction associated with the smart contract, including links among the order, escrow, delivery verification, and settlement records for audit and reporting.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer system for blockchain-based commodity and financial transactions, the system comprising:
at least one server comprising at least one processor and a memory storing an application;
at least one user computing device for a seller and at least one user computing device for a buyer, and at least one user computing device for a government agent each in operable communication with the at least one server via a network; and
a database in communication with the at least one server;
wherein the application, when executed by the at least one processor, is configured to:
authenticate the seller and the buyer and establish respective accounts;
receive, from the seller, a listing comprising a commodity identifier, quantity, quality attributes, delivery terms, and a price;
generate a smart contract for the listing that specifies at least a seller identification, a buyer identification, a wallet address or banking information, an order identification, a contract identification, milestone events comprising shipment and delivery, government tariffs and fees, and settlement terms;
commit the smart contract to a blockchain ledger using a blockchain interface;
escrow funds for the listing in association with the smart contract; obtain shipment and delivery status from an oracle interface;
verify delivery by comparing the shipment and delivery status with the milestone events;
release at least a portion of the escrowed funds upon verifying the delivery;
record a settlement on the blockchain ledger; and
update the database to reflect completion of a transaction associated with the smart contract.

2. The computer system of claim 1, wherein the blockchain ledger comprises at least one of a Ripple XRPL ledger, Ethereum (Ethereum+ERC-3643 or Hyperledger Fabric), HBAR, or Polkadot for smart contract governance, RBAC, multi-signature workflows and regulatory reporting.

3. The computer system of claim 1, wherein escrowing the funds comprises establishing a multisignature escrow that requires signatures from at least two of the seller, the buyer, and a neutral intermediary before releasing the funds.

4. The computer system of claim 1, further comprising a compliance engine configured to determine jurisdiction-specific taxes, tariffs, and regulatory fees and to insert corresponding parameters into the smart contract prior to committing the smart contract to the blockchain ledger.

5. The computer system of claim 1, wherein the oracle interface receives carrier tracking updates from a logistics oracle and maps carrier events to the milestone events defined in the smart contract.

6. The computer system of claim 1, further comprising an identity module configured to authenticate the seller and the buyer using decentralized identifiers and to perform know-your-customer and anti-money-laundering verification before authorizing payment.

7. The computer system of claim 1, wherein the database implements a schema comprising tables corresponding to a data model having at least:
a blockchain table storing a chain identifier and a block hash;
a user table storing a user identifier and a wallet address;
an order table storing an order identifier, a buyer identifier, a seller identifier, a commodity identifier, and an order status;
a smart-contract table storing a contract identifier and terms;
a commodity table storing a commodity identifier, a name, and pricing data;
a delivery-verification table storing a verification identifier, an order identifier, and a delivery status; and
a transaction table storing a transaction identifier, an order identifier, a buyer identifier, a seller identifier, and an amount.

8. The computer system of claim 1, wherein the application is further configured to compute a reputation score by receiving feedback and ratings from the seller and the buyer after the recording of the settlement and storing the feedback and ratings in the database in association with respective accounts.

9. A computer-implemented method for managing a blockchain-based commodity transaction, the method comprising:
authenticating, by a server, a seller, a buyer, and government establishing respective accounts;
receiving, from the seller, a listing comprising a commodity identifier, quantity, quality attributes, delivery terms, and a price;
generating, by the server, a smart contract that specifies at least a seller identification, a buyer identification, a wallet address or banking information, an order identification, a contract identification, predefined milestone events, and settlement terms;
committing the smart contract to a blockchain ledger;
escrowing, in association with the smart contract, funds for the listing;
receiving shipment and delivery status from an external logistics system via an oracle interface;
verifying delivery by comparing the shipment and delivery status with the predefined milestone events;
releasing at least a portion of the escrowed funds based on the verifying;
recording a settlement on the blockchain ledger; and
updating a database to reflect completion of a transaction associated with the smart contract.

10. The method of claim 9, wherein the blockchain ledger comprises a Ripple XRPL ledger.

11. The method of claim 9, wherein generating the smart contract comprises defining a plurality of milestone transactions with respective release conditions that collectively cover payment from initiation through delivery verification and settlement.

12. The method of claim 9, further comprising writing, to the database, a chain identifier and a block hash associated with the recording of the settlement on the blockchain ledger.

13. The method of claim 9, wherein escrowing the funds comprises receiving a fiat currency payment from the buyer, converting at least a portion of the fiat currency to a cryptocurrency, and holding the cryptocurrency in escrow associated with the smart contract or re-converting it into fiat and holding the fiat funds in an escrow bank account.

14. The method of claim 9, further comprising, in response to inspection data received via the oracle interface that indicates a discrepancy with the delivery terms, executing a programmatic dispute resolution defined by the smart contract to either return the escrowed funds to the buyer or transfer a portion of the escrowed funds to the seller.

15. The method of claim 9, further comprising storing feedback and ratings from the seller and the buyer and computing a reputation update anchored to the blockchain ledger for tamper-evident recordation.

16. A non-transitory computer-readable medium storing instructions that, when executed by at least one processor of a server, cause the server to:
authenticate a seller and a buyer and establish respective accounts;
receive a commodity listing from the seller;
generate a smart contract comprising at least a seller identification, a buyer identification, a government identification, a wallet address or banking information, an order identification, a contract identification, milestone events, and settlement terms;
commit the smart contract to a blockchain ledger;
escrow funds for the commodity listing in association with the smart contract;
receive shipment and delivery status via an oracle interface;
verify delivery by comparing the shipment and delivery status to the milestone events;
release at least a portion of the escrowed funds based on the verifying;
record a settlement on the blockchain ledger; and
update a database to reflect completion of a transaction associated with the smart contract.

17. The non-transitory computer-readable medium of claim 16, wherein the instructions further cause the server to manage the escrow funds using a multisignature escrow that requires at least two signatures selected from the seller, the buyer, and a neutral intermediary before releasing the funds.

18. The non-transitory computer-readable medium of claim 16, wherein the instructions further cause the server to authenticate the seller and the buyer using decentralized identifiers and to perform know-your-customer and anti-money-laundering verification prior to enabling payment.

19. The non-transitory computer-readable medium of claim 16, wherein the instructions further cause the server to enforce jurisdiction-specific compliance rules by computing taxes, tariffs, and regulatory fees for a destination and inserting corresponding values into parameters of the smart contract.

20. The non-transitory computer-readable medium of claim 16, wherein the instructions further cause the server to update an on-chain inventory record corresponding to the commodity listing responsive to order execution by invoking a hook supported by the blockchain ledger to adjust an available quantity in real time.
